(19) United States
(12) Patent Application Publication
(10) Pub. No.: US 2006/0175349 A1
(43) Pub. Date: Aug. 10, 2006

(54) Scented dispensing fitment for bottles delivering household care liquid products

(75) Inventors: Kimberly Ann Drosos, Monroe, CT (US); May Shana'a, Trumbull, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/120,892

(22) Filed: May 3, 2005

Related U.S. Application Data
(60) Provisional application No. 60/651,415, filed on Feb. 9, 2005.

(51) Int. Cl. B67D 1/16

(52) U.S. Cl. 222/109

(57) ABSTRACT

A package for a liquid household care composition is provided which eliminates any foul smelling odors emanating from the composition. The package includes a unitarily molded bottle having a container area formed from plastic walls and an open and a closed end, the open end including a neck area with an open mouth. A cap is present for reclosably covering the open mouth. A dispensing fitment such as a pour spout is molded separate from the bottle and supported adjacent the neck area. Plastic walls of the fitment include an aroma control agent, advantageously present within an encapsulating matrix. Walls of the bottle are substantially free of the aroma control agent.

### BACKGROUND OF THE INVENTION

1. Field of the Invention

The invention concerns a bottle with a dispensing fitment embedded with aroma or other scent modifying chemicals that slowly releases the chemicals to provide a pleasant experience or mask malodor of liquid household care products held within the bottle.

2. The Related Art

Liquid household care products such as fabric conditioner and heavy duty laundry liquids often emanate malodor from the base formulations. Fragrances are incorporated into these formulations to cover the unpleasant odor. Often this approach is insufficient to fully counteract malodor in otherwise excellently functioning products.

Consumers shopping in stores for liquid household products have a habit of unscrewing bottle caps to smell a product's fragrance. Preference for a perfume is key to their purchase decision. Consumers must be reassured the product will make their clothes smell fresh and clean.

One approach to the problem has been to incorporate aroma chemicals directly into the walls of the bottle, the bottle closure (such as into the screw-on cap) or into both parts. The drawbacks to placing the aroma into walls of the bottle are cost, scent dissipation and “air pollution”. Bottles are relatively large pieces of plastic; it is economically wasteful to place aroma chemicals throughout all the plastic walls forming the container. Secondly, over time the aroma will seep out from the bottle walls becoming unavailable for the critical consumer sniff test. Concomitantly the escaped aromas will pollute air in the shopping store aisles. Addition of the aroma chemicals merely to the closure also suffers from dissipation.

Accordingly, it would be desirable to provide a bottle for household care liquid compositions dispensable from the bottle via a dispensing fitment wherein a pleasant odor is experienced or any malodor from the liquid is masked from a consumer when sniffing a dispensing orifice of the bottle.

### SUMMARY OF THE INVENTION

A package is provided which includes:
(i) a unitarily molded bottle including a container area formed from plastic walls and having an open and a closed end, the open end including a neck area with an open mouth;
(ii) a cap for reclosably sealing the open mouth;
(iii) a dispensing fitment molded separate from the bottle and cap, supported adjacent the neck area, and formed of plastic walls, the walls of the fitment comprising an aroma control agent, the walls of the bottle being substantially free of the aroma control agent.

Also provided is a packaged liquid household care product that includes the above-described package and a liquid laundry detergent or a liquid fabric softening composition held within the bottle of the package.

### DETAILED DESCRIPTION OF THE DRAWING

Various features of the present invention are described in the accompanying drawings in which:

FIG. 1 is a perspective view of a package according to the present invention;

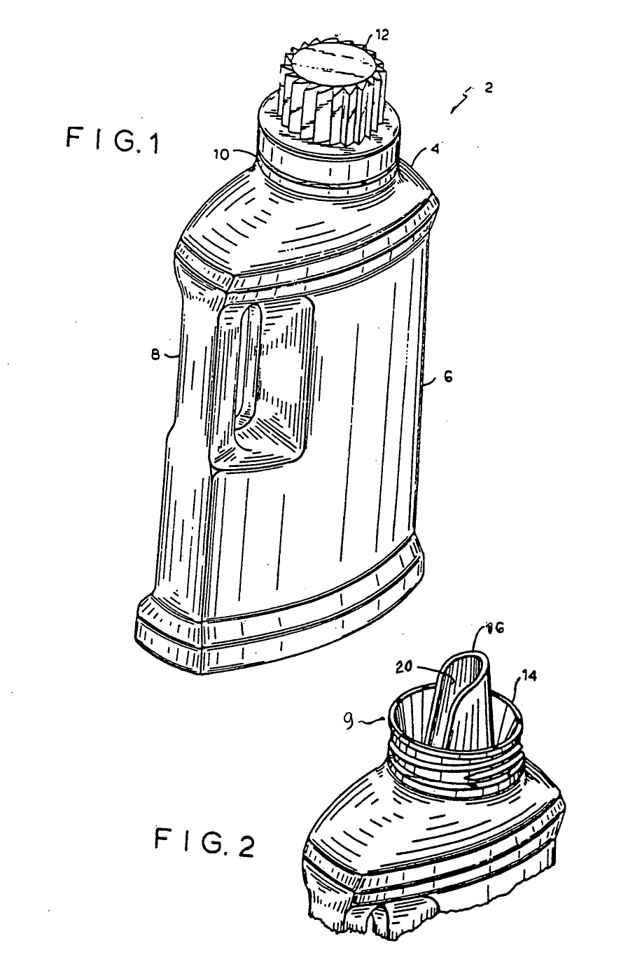

FIG. 2 is a perspective fragmentary view of the package with the cap removed;

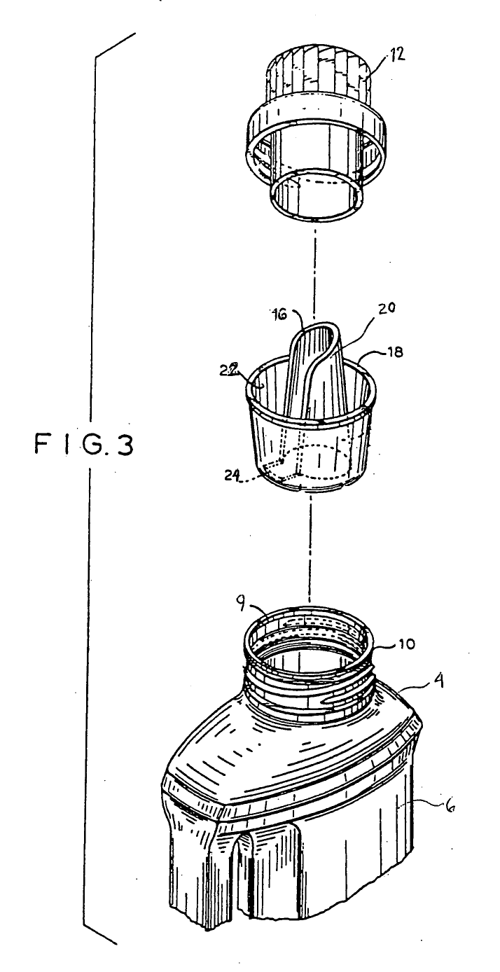

FIG. 3 is an exploded perspective view of the package; and

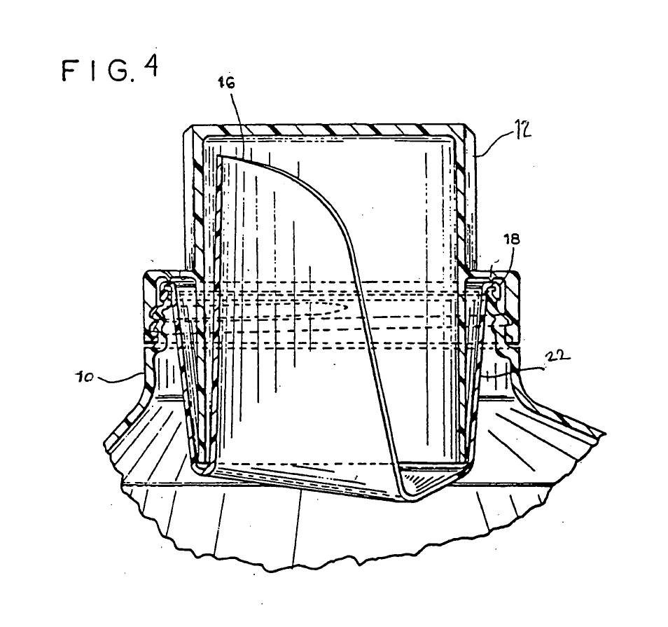

FIG. 4 is a fragmentary sectional elevation view along a neck area of the package.

### DETAILED DESCRIPTION OF THE INVENTION

Now it has been found that malodor issuing from a household care liquid such as a laundry detergent or fabric softening composition can be counteracted by molding into the plastic of a dispensing fitment (e.g. pour spout) an aroma control agent. Advantageously, the aroma control agent is delivered into the plastic fitment in an encapsulated format from which the agent can be slowly released.

In a preferred embodiment, the package of this invention is a unitarily molded bottle having a container area formed from plastic walls and having an open and a closed end. The open end includes a neck area with an open mouth. A cap is present on the package for reclosably sealing the open mouth. The dispensing fitment is molded separate from the bottle and the cap. The fitment is supported adjacent the neck area.

In a preferred embodiment the bottle and the cap are substantially free (advantageously no more than about 0.1%) of any aroma control agent. A benefit for the preferred embodiment is that aroma control agent remains confined inside the package awaiting sniff investigation by a consumer. Also it is appropriately situated near the open mouth of the bottle to allow greatest consumer impact. Absence of the aroma control agent from the bottle or cap avoids extra costs, but even more important lessens potential pollution of store areas surrounding the package displays.

In accordance with the present invention, the aroma control agent may also be placed within the liquid household care product. Yet another embodiment allows the aroma control agent formed into the dispensing fitment to be different from any fragrance formulated with the household care liquid composition. In a most preferred embodiment, the aroma control agent will be a fragrance having a scent as close as possible to that of the dried cloths treated with laundry or fabric softening compositions.

The aroma control agent may be in the form of a signature perfume which is pleasant for a consumer to smell. Alternatively the agent may be one or more chemicals that unlike a perfume which masks malodor would actually neutralize foul-smelling components of the household care liquid composition. Here the consumer would sense neither pleasant nor unpleasant scent from the packaged product.

For purposes of this invention, the term “aroma control agent” means one or more aroma modifying chemicals. Ordinarily the number of these chemicals may range from about 3 to about 1000, preferably from about 5 to about 200, optimally from about 8 to about 50.

FIG. 1 illustrates a package 2 according to the present invention. This package includes a bottle 4 having a container area 6 and an integral handle 8. The bottle has an open and a closed end, the open end including a neck area 10 with an open mouth 9.

A cap 12 reclosably seals the open mouth. As best viewed in FIGS. 2 and 3, the cap is fitted with a female screw thread which can be threadably tightened over complementary male threads along an outer wall of the neck area. Alternatively the cap can be fitted with a male screw thread along a lower perimeter for insertion into a complimentary thread along an inner wall of the neck area.

A drainback dispensing fitment 14 in the form of a pour spout 16 is supported along inner walls of the neck area through a lip 18 and a friction fit. The pour spout features a frustoconical wall portion 20 which gradually tapers downwardly and inwardly. Wall portion 20 is circumferentially surrounded by a downwardly tapering outer wall portion 22 bounded along an upper end by lip 18 and a lower end by a drainage channel 24.

Walls of the pour spout, bottle and cap may be made from the same or different plastic materials. These walls may be fabricated as a single layer or as multi layer walls. In many instances, there will be three or more layers. Plastic materials of construction generally are selected from high density polyethylene, low density polyethylene, polypropylene and mixtures thereof.

Although the invention has been described in the context of a pour spout as the dispensing fitment, other embodiments are also within the scope and intent of this invention. For instance, a dosing cup may be tensioned within the cap. The auto dosing cup will be supported adjacent the neck area of the bottle when the cap has been applied thereto in closure position. In other words, the dispensing fitment may be supported either within the neck or within the cap. Both positionings insure that a pleasant or masking odor from the aroma control agent is available at the product dispensing orifice.

Household care bottles, fitments and caps are normally manufactured by injection molding. This process is based on injecting molten plastic under high temperature and pressure into a steel mold. An injection-molding machine consists of two principal parts, i.e. an injection unit and a clamp unit. The injection unit melts the plastic and injects it into the mold. The clamp unit opens, closes and holds the mold closed against the pressure of the melt. Injection-molding machines are usually operated by hydraulic power, and machines are supplied with an electric motor and hydraulic pump. A hydraulic cylinder opens and closes the mold, another pushes the screw forward, thereby injecting melt into the mold and a hydraulic motor turns the screw. Control of these movements is a combined function of the hydraulic system and the electrical system.

Refrigeration systems are used to cool molds for rapid cycle times. Lubricants are often added to resins to render injection easier and allow molding on a shorter cycle. For purposes of the present invention, the aroma control agent, the encapsulation matrix and liquid carrier can all serve as lubricants for the polymer resins.

It should be understood that although injection molding has been described as a preferred manufacturing process for dispensing fitments, other processes may also find utility in accordance with this invention. Examples include extrusion coating, compression molding, blow molding, rotational molding and thermoforming to mention but a few possibilities.

In a preferred embodiment, the cap of this invention is formed of polypropylene. Walls of the bottle are formed of three layers. The outer layer preferably is high density polyethylene, the middle layer is a combination of high density polyethylene/post-consumer recycled resin/reground resin, and the inner layer again of high density polyethylene. Metallocene polymerized polyethylene can be utilized in versions seeking greater light transmittance. Similar construction can be used for walls of the dispensing fitment.

The aroma control agent in a preferred embodiment is delivered into an injection molding machine as an encapsulated substance suspended in a liquid carrier. This stream of encapsulate is mixed with polymer resin, particularly high density polyethylene, within the injection molding machine. Process temperatures are maintained between about 30° C. to about 400° C., preferably from about 50° C. to about 250° C., optimally from about 100° C. to about 180° C.

Aroma control agent may be incorporated into walls of the dispensing fitment during the manufacture process. Herein polymers and various other additives are fed into a die cavity of the injection molding unit, subjected to heat (and in some instances pressure) to form the desired molded article. Often the polymer is delivered to the injection molding machine as pellets fed via a hopper. Other additives include colorants, plasticizers and stabilizing agents.

Agents of the present invention can be mixed with or pre-incorporated into the polymer pellets. Yet in a preferred embodiment are separately delivered into the die cavity, most preferably pumped as a fluid feed stream.

Advantageously the aroma control agent prior to injection molding is encapsulated within a matrix. This permits easier handling without loss of more highly volatile aroma chemicals of the control agent mixture during transport and molding, and allows for slow release of the control agent. Encapsulating matrices include compounds and polymers structurally different from the polymer forming the majority of the dispensing fitment walls. Examples of organic encapsulating matrices include vegetable or petroleum waxes, polyurethanes, polyacrylates, cellulosics (e.g. hydrophobically modified cellulose such as hydroxypropyl cellulose), low molecular weight (<1000) esters, polysaccharides and mixtures thereof. Organic substances particularly suitable are waxes, polysaccharides and esters. Illustrative waxes are carnauba, candillia, ceresin, beeswax and mixtures thereof. Petroleum derived polyethylene waxes are also useful. Plasticizing esters such as dibutyl phthalate are suitable. Most useful are triglycerides such as the vegetable oils of sunflower seed oil, cottonseed oil, peanut oil, soybean oil and castor oil. Fatty acids and alcohols with 12-22 carbon atoms are also potential encapsulating matrices; stearic acid and stearyl alcohol are illustrative. Inorganic matrices may also be employed. Illustrative are aluminosilicates such as zeolites, silicas such as fumed silica, carbonates, clays and other highly porous substances. Mean particle sizes may range from about 10 nanometers to about 5 millimeters, preferably from about 100 nm to about 1,000 nm, optimally from about 200 to about 500 nm.

Advantageously, the matrix for encapsulation is a material more hydrophilic than that of the polymer forming a majority of the dispensing fitment wall. Differences in density between the matrix and majority of polymer in the wall is also useful Different phobicity and/or dielectric constant and/or lower density of the encapsulating matrix allow the encapsulated aroma control agent to concentrate closer to outer surfaces of the molded plastic fitment.

Encapsulates containing the aroma control agent can be delivered for manufacturing purposes via a medium rendering the combination liquid at room temperature.

Aroma control agents can be grouped into several classes. These classes are enduring (non-volatile) perfumes, volatile perfumes, pro-accords and deodorizers (e.g. uncomplexed cyclodextrin). Agents from each of these classes will be chosen dependent upon manufacturing temperatures for producing fitments, type of resins used in the fitments, type of malodor emanating from a specific laundry detergent or fabric softening composition, strength necessary of the scent within head space of the bottle neck, and shelf life requirements.

An enduring perfume ingredient is characterized by its boiling point (B.P.) and its octanol/water partitioning coefficient (P). The octanol/water partitioning coefficient of a perfume ingredient is the ratio between its equilibrium concentrations in octanol and in water. The perfume ingredients of this class have a B.P., measured at a normal, standard pressure, of about 250° C. or higher, preferably more than about 260° C.; and an octanol/water partitioning coefficient P of about 1,000 or higher. Since the partitioning coefficients of the perfume ingredients of this class have high values, they are more conveniently given in the form of their logarithm to the base 10, logP. Thus the perfume ingredients of this class have logP of about 3 or higher, preferably more than about 3.1, and even more preferably more than about 3.2.

The boiling points of many perfume ingredients are given in, e.g., “Perfume and Flavor Chemicals (Aroma Chemicals),” Steffen Arctander, published by the author, 1969, incorporated herein by reference.

The logP of many perfume ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present class.

The enduring perfume compositions contain at least about 3 different enduring perfume ingredients, more preferably at least about 4 different enduring perfume ingredients, and even more preferably at least about 5 different enduring perfume ingredients. Furthermore, the enduring perfume compositions contain at least about 70 wt % of enduring perfume ingredients, and even more preferably at least about 85 wt % of enduring perfume ingredients.

In the perfume art, some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., solubilizing or diluting some solid or viscous perfume ingredients to, e.g., improve handling and/or formulating, or stabilizing volatile ingredients, e.g., by reducing their vapor pressure. These materials are not counted in the definition/formulation of the enduring perfume compositions.

The second class of aroma control agent are the highly volatile perfumes. These are characterized by perfume ingredients of boiling point less than about 220° C. and having a ClogP no higher than about 3. In this category, at least about 25%, more preferably at least about 50%, most preferably at least about 75%, by weight of the perfume is composed of fragrance material selected from the group consisting of aromatic and aliphatic esters having molecular weights from about 130 to about 250; aliphatic and aromatic alcohols having molecular weights from about 90 to about 240; aliphatic ketones having molecular weights from about 150 to about 260; aromatic ketones having molecular weights from about 150 to about 270; aromatic and aliphatic lactones having molecular weights from about 130 to about 290; aliphatic aldehydes having molecular weights from about 150 to about 200; aromatic aldehydes having molecular weights from about 90 to about 230: aliphatic and aromatic ethers having molecular weights from about 150 to about 270; and condensation products of aldehydes and amines having molecular weights from about 180 to about 320; and essentially free from nitromusks and halogenated fragrance materials.

Non-limiting examples of perfume ingredients which have Clog P values of about 3 or smaller are coumarin, dihydromyrcenol, dimethyl benzyl carbinyl acetate, ethyl vanillin, eucalyptol, eugenol, iso eugenol, flor acetate, hydroxycitronellal, koavone, linalool, methyl beta naphthyl ketone, methyl dihydro jasmonate, nerol, nonalactone, phenyl ethyl acetate, alpha terpineol, beta terpineol, vanillin, anethole, benzaldehyde, benzyl acetate, benzyl alcohol, benzyl formate, isobornyl acetate, camphene, cis-citral (neral), citronellal, citronellol, citronellyl acetate, paracymene, decanal, dihydrolinalool, geranial, geraniol, geranyl acetate, geranyl nitrile, cis-3-hexenyl acetate, d-limonene, linalool, linalool oxide, linalyl acetate, linalyl propionate, methyl anthranilate, alpha-methyl ionone, methyl nonyl acetaldehyde, methyl phenyl carbinyl acetate, laevomenthyl acetate, menthone, iso-menthone, myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, vertenex (para-tertiary-butyl cyclohexyl acetate) and mixtures thereof. Some natural oils also contain large percentages of highly volatile perfume ingredients. For example, lavandin contains as major components: linalool; linalyl acetate; geraniol; and citronellol. Lemon oil and orange terpenes both contain about 95% of d-limonene.

A third class of aroma control agent for use in the present invention are the pro-accords. Pro-accords slowly release fragrance for materials upon contact with moisture. They provide sustained perfume and fragrance retention under manufacturing conditions yet upon exposure to a moist environment such as above an aqueous laundry or fabric softener composition, they slowly release scent thereby becoming malodor control agents. Pro-accord compositions often are combined with volatile fragrances. Orthoesters have particularly been useful as a pro-accord vehicle. Illustrative of this category is tri(geranyl)orthoformate. Hydrolysis of the pro-accord releases geraniol and geranyl formate as volatile constituents. Another category of pro-accord are the ketal materials. Illustrative is bis(linalyl)beta-ionone ketal which upon hydrolysis releases linalool/beta-ionone. Still a further class are the orthocarbonates. Illustrative is tetrakis(cinnamyl)orthocarbonate which upon hydrolysis releases cinnamyl alcohol.

Yet a still further class of aroma control agent are deodorizers, particularly the cyclodextrins. As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in a donut-shaped ring. The specific coupling and conformation of the glucose units give the cyclodextrins a rigid, conical molecular structure with a hollow interior of a specific volume. The “lining” of the internal cavity is formed by hydrogen atoms and glycosidic bridging oxygen atoms, therefore this surface is fairly hydrophobic. The unique shape and physical-chemical property of the cavity enable the cyclodextrin molecules to absorb (form inclusion complexes with) organic molecules or parts of organic molecules which can fit into the cavity. It is to be noted that cyclodextrins may be utilized by themselves or in combination with aroma control agents from other of the three classes identified above.

Amounts of the aroma control agent within the dispensing fitment may range from about 0.00001 to about 20%, preferably from about 0.0001 to about 10%, optimally from about 0.1 to about 5% by weight of the fitment. Amounts of the aroma control agent within an encapsulating matrix may range from about 0.001 to about 95%, preferably from about 1 to about 50%, optimally from about 5 to about 20% by weight of the total encapsulating matrix.

Packages according to the present invention can be utilized with a wide variety of liquid chemical products. However, the package is most useful for household care liquids. These include laundry detergent compositions and fabric care compositions.

Laundry detergent compositions may be formulated with detersive surfactants, detergency builders and optional ingredients such as enzymes, bleaching agents, soil release agents, anti-redeposition agents, polymeric dispersing agents, dye transfer inhibiting agents, suds suppressors, fabric softeners, colorants, hydrotropes, perfumes and usually combinations thereof.

Detersive surfactants are normally formulated in a range from about 5 to about 85%. They can be anionic and nonionic surfactants and mixtures thereof. Particularly suitable as anionic surfactants are alkyl sulfates, alkyl sulfonates, alkyl benzene sulfonates and alkyl ether sulfates. The nonionics are usually C₁₂-C₁₈ alkyl alkoxylates formed from fatty acids and fatty alcohols. Detergency builders may be present in amounts from about 5 to about 50% by weight. Typical builders are sodium tripolyphosphate, zeolites, silicates, sodium carbonates, citrates and combinations thereof. When present the enzymes may be selected from protease, amylase, lipase, cellulase, peroxidase and combinations thereof. Bleaching agents may be present in amounts from about 0.5 to about 30% by weight. Illustrative are sodium perborate, sodium percarbonate, magnesium monoperoxyphthalate which can be combined with catalysts such as: nonanoyloxybenzene sulfonate or tetraacetyl ethylene diamine. Polymeric soil release agents typically are cellulosics such as hydroxypropyl methyl cellulose or polymers such as Sokalan® type polycarboxylates. Chelating agents may be formulated typified by Dequest® phosphonate chemicals and ethylene diamine tetraacetate. Soil removal/anti-redeposition agents are represented by carboxymethyl cellulose and ethoxylated amines. Polymeric dispersing agents ordinarily are polymeric polycarboxylates. Optical brighteners are available under the Tinopal® and Phorwhite® brands. Dye transfer inhibiting agents are represented by polyvinyl pyrrolidone polymers and co-polymers. Suds suppressors typically are petrolatum and polymethyl siloxane chemicals. Hydrotropes are represented by xylene sulphonate. Carriers for these liquids normally is water.

Fabric softening compositions are less complex than laundry detergent compositions. The active ingredients of fabric softeners typically are cationic fatty compounds, sometimes in combination with nonionic alkoxylates. These are typified by di(C₁₂-C₂₂) alkyl-di(C₁-C₄) alkyl ammonium salts. Representative is di(tallow) dimethylammonium sulphate. Fabric softening actives are formulated in ranges from about 1 to about 20% by weight. Optionally present are colorants, C₁₂-C₂₂ fatty alcohols and acids, optical brighteners, antimicrobials (preservatives), perfume and water. Amounts of water may range from about 50 to about 98% by weight.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

What is claimed is:

1. A package comprising:
(i) a unitarily molded bottle comprising a container area formed from plastic walls and having an open and a closed end, the open end comprising a neck area with an open mouth;
(ii) a cap for reclosably sealing the open mouth;
(iii) a dispensing fitment molded separate from the bottle and cap, supported adjacent the neck area, and formed of plastic walls, the walls of the fitment comprising an aroma control agent, the walls of the bottle being substantially free of the aroma control agent.

2. The package according to claim 1 wherein the aroma control agent is encapsulated within a matrix allowing slow release of the aroma control agent.

3. The package according to claim 2 wherein the matrix is selected from the group consisting of vegetable and petroleum waxes, polyurethanes, polyacrylates, cellulosics, low molecular weight (less than 1000) organic esters, polysaccharides, inorganic materials and combinations thereof.

4. The package according to claim 1 wherein the cap is substantially free of the aroma control agent.

5. The package according to claim 1 wherein the aroma control agent is selected from the group consisting of an enduring perfume, a volatile fragrance, a pro-accord, a cyclodextrin, and mixtures thereof.

6. The package according to claim 1 wherein the walls of the bottle contain no more than about 0.1% of the aroma control agent.

7. A packaged liquid household care product comprising:
(A) a package comprising:
(i) a unitarily molded bottle comprising a container area formed from plastic walls and having an open and a closed end, the open end comprising a neck area with an open mouth;
(ii) a cap for reclosably sealing the open mouth;
(iii) a dispensing fitment molded separate from the bottle and cap, supported adjacent the neck area, and formed of plastic walls, the walls of the fitment comprising an aroma control agent, the walls of the bottle being substantially free of the aroma control agent; and
(B) a liquid laundry detergent or liquid fabric softening composition held within the bottle.

8. The product according to claim 7 wherein the aroma control agent is encapsulated within a matrix allowing slow release of the aroma control agent.

9. The product according to claim 8 wherein the matrix is selected from the group consisting of vegetable and petroleum waxes, polyurethanes, polyacrylates, cellulosics, low molecular weight (less than 1000) organic esters, polysaccharides, inorganic materials and combinations thereof.

10. The product according to claim 7 wherein the cap is substantially free of the aroma control agent.

11. The package according to claim 7 wherein the aroma control agent is selected from the group consisting of an enduring perfume, a volatile fragrance, a pro-accord, a cyclodextrin, and mixtures thereof.
